(19) United States
(12) Patent Application Publication
(10) Pub. No.: US 2012/0127502 A1
(43) Pub. Date: May 24, 2012

(54) Method of performing operations in image forming apparatus, image forming apparatus and image forming system for performing the method

(75) Inventors: Jae-ho Kim, Suwon-si (KR); Jin-ah Heo, Seoul (KR)

(73) Assignee: SAMSUNG ELECTRONICS CO.,LTD., Suwon-si (KR)

(21) Appl. No.: 13/317,247

(22) Filed: Oct. 13, 2011

(30) Foreign Application Priority Data
Nov. 19, 2010 (KR) 10-2010-0115759

(51) Int. Cl. G06F 15/00

(52) U.S. Cl. 358/1.13

(57) ABSTRACT

A method of performing operations in an image forming apparatus, the image forming apparatus and an image forming system for performing the method. The method includes: determining whether a user selects an input button for performing a predetermined operation on image data obtained by capturing from a host device connected to the image forming apparatus; if it is determined that the input button is selected, determining a current operation mode of the image forming apparatus from among the plurality of operation modes; and performing an operation, which was previously set in correspondence to the operation mode, on the image data, according to a result of the determining.

### CROSS-REFERENCE TO RELATED APPLICATIONS

This application claims the priority benefit of Korean Patent Application No. 10-2010-0115759, filed on Nov. 19, 2010, in the Korean Intellectual Property Office, the disclosure of which is incorporated herein in its entirety by reference.

### BACKGROUND

1. Field

Embodiments relate to a method of performing operations in an image forming apparatus, the image forming apparatus and an image forming system for performing the method.

2. Description of the Related Art

Image forming apparatuses including printers, scanners, and multi-function peripherals may perform at least one of various functions such as a printing function, a copying function, a scanning function, a facsimile sending/receiving function, an e-mail sending/receiving function, and a function of sending files to a server. However, there is an inconvenience in that various operations, such as a printing operation, a storing operation, etc., may be performed on image data obtained by capturing from a host device connected to an image forming apparatus, only by using additional applications such as an image editing program (e.g., Paint, Photoshop, etc.).

### SUMMARY

One or more embodiments relate to a method of performing operations in an image forming apparatus for easily performing various operations on image data obtained by capturing from a host device, the image forming apparatus and an image forming system for performing the method.

One or more embodiments relate to a non-transitory computer-readable recording medium having embodied thereon a program to implement the method which is executed by one or more processors.

According to an aspect of one or more embodiments, there is provided a method of performing operations in an image forming apparatus in which a plurality of operation modes may be set, the method including: determining whether a user selects an input button for performing a predetermined operation on image data obtained by capturing from a host device connected to the image forming apparatus; if it is determined that the input button is selected, determining a current operation mode of the image forming apparatus from among the plurality of operation modes; and performing an operation, which was previously set in correspondence to the operation mode, on the image data, according to a result of the determining.

According to another aspect of one or more embodiments, there is provided a method of performing operations in an image forming apparatus, the method including: setting an operation to be performed, when an input button included in the image forming apparatus is selected; and if it is determined that the input button included in the image forming apparatus is selected, performing an operation according to the setting on image data obtained by capturing from a host device connected to the image forming apparatus.

According to another aspect of one or more embodiments, there is provided a non-transitory computer-readable recording medium having embodied thereon a program to implement the method which is executed by one or more processors.

According to another aspect of one or more embodiments, there is provided a non-transitory computer-readable recording medium having embodied thereon a program to implement the method which is executed by one or more processors.

According to another aspect of one or more embodiments, there is provided an image forming apparatus in which a plurality of operation modes may be set, the image forming apparatus including: a user interface unit including an input button for performing a predetermined operation on image data obtained by capturing from a host device connected to the image forming apparatus; a control unit to determine whether the input button is selected by a user; and an operation mode determination unit to determine a current operation mode of the image forming apparatus from among the plurality of operation modes, if it is determined that the input button is selected by the user, wherein the control unit controls the operation, which was previously set in correspondence to the operation mode to be performed, on the image data according to a result of the determination.

According to another aspect of one or more embodiments, there is provided a system to perform an operation including an image forming apparatus and a host device connected to the image forming apparatus, the system including: an image forming apparatus to determine whether a user selects an input button for performing a predetermined operation on image data obtained by capturing from a host device connected to the image forming apparatus, to determine, if it is determined that the input button is selected, a current operation mode from among a plurality of operation modes, and to request image data to perform an operation, which was previously set in correspondence to the operation mode, according to a result of the determination; and a host device to provide image data obtained by capturing according to the request to the image forming apparatus, wherein the image forming apparatus performs the previously set operation by using the provided image data.

### BRIEF DESCRIPTION OF THE DRAWINGS

The above and other aspects of embodiments will become more apparent by describing in detail exemplary embodiments thereof with reference to the attached drawings in which:

FIG. 1 is a diagram illustrating a usage environment of an image forming apparatus, according to an embodiment;

FIG. 2 is a block diagram illustrating the image forming apparatus of FIG. 1;

FIG. 3 is a detailed block diagram illustrating the image forming apparatus, a host device, and an external device, according to an embodiment;

FIG. 4 is a flowchart illustrating a method of performing operations in the image forming apparatus, according to an embodiment;

FIG. 5 is a flowchart illustrating a method of setting-up setting information in the image forming apparatus and of determining an operation mode, according to an embodiment;

FIG. 6 is a flowchart illustrating data-flow between the image forming apparatus and the host device, when the image forming apparatus is in a scan mode, according to an embodiment;

FIG. 7 is a flowchart illustrating data-flow between the image forming apparatus and the host device, when the image forming apparatus is in a printing mode, according to an embodiment;

FIG. 8 is a flowchart illustrating data-flow between the image forming apparatus and the host device, when the image forming apparatus is in a transmission mode, according to an embodiment; and

FIG. 9 is a flowchart illustrating a method of performing operations in an image forming apparatus, according to another embodiment.

### DETAILED DESCRIPTION

Embodiments will now be described more fully with reference to the accompanying drawings.

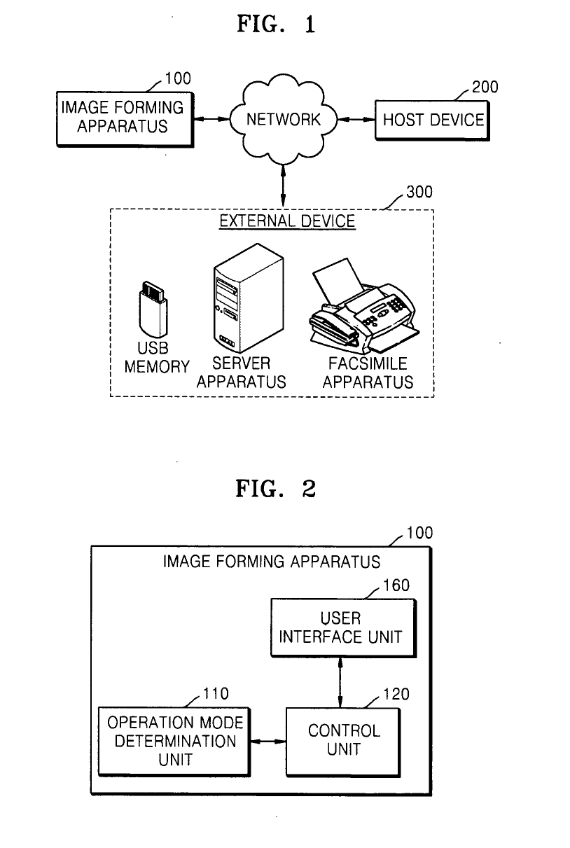

FIG. 1 is a diagram illustrating a usage environment of an image forming apparatus 100, according to an embodiment. Referring to FIG. 1, the image forming apparatus 100 may be connected to a host device 200 and an external device 300.

Referring to FIG. 1, one image forming apparatus 100, one host device 200, and one external device 300 are illustrated. However, it is understood that embodiments are not limited to FIG. 1, for example, one or more image forming apparatuses 100 may be connected to one or more host devices 200 and one or more external devices 300.

The image forming apparatus 100, the host device 200, and the external device 300 of FIG. 1 may transmit and receive data through a wired network, wireless network or wire-wireless (hybrid) network or by wired series communication by using a communication module installed in each of the image forming apparatus 100, the host device 200, and the external device 300. In this case, the wire-wireless network may include internet, a local area network (LAN), a wireless LAN, a wide area network (WAN), a personal area network (PAN), etc. However, embodiments are not limited thereto, and the wire-wireless network may include other different types of networks via which data is transmitted and received.

The image forming apparatus 100 may include a printer, a scanner, a multi-function peripheral (MFP), etc. Thus, the image forming apparatus 100 may perform various operations, for example, printing, scanning, copying, facsimile sending/receiving, e-mail sending/receiving, and sending of files to a server. However the image forming apparatus 100 may further perform various other operations according to a usage environment.

The host device 200 may control the image forming apparatus 100 and may be any device connected to, for example, a general-purpose computer system, a personal digital assistant (PDA), or the like.

The external device 300 may be any device connected to the image forming apparatus 100 through a wired network, wireless network or wire-wireless (hybrid) network or by wired series communication. For example, the external device 300 may not only be a universal serial bus (USB) memory or a facsimile sending/receiving apparatus but may also be a general-purpose computer system, a server apparatus, a digital living network alliance (DLNA) apparatus, or the like existing on a network.

One of ordinary skill in the art would understand that the server apparatus (e.g. FIG. 1) may not only be a file transfer protocol (FTP) server, a server message block (SMB) server, or the like, but may also be an e-mail server for sending/receiving e-mails.

As described above, a plurality of operation modes may be set in the image forming apparatus 100, and the image forming apparatus 100 may perform one or more operations according to a currently set operation mode from among the plurality of operation modes. That is, the operation mode refers to a state of the image forming apparatus 100 for performing predetermined work. For example, the plurality of operation modes may include a scan mode for performing scanning, a printing mode for performing printing, a transmission mode for performing a facsimile transmitting operation and an e-mail transmitting operation. In addition, one of ordinary skill in the art would understand that the above-described printing mode and transmission mode may be respectively referred to as a copy mode and a facsimile mode.

When an input button included in the image forming apparatus 100 is selected, the image forming apparatus 100 performs one or more operations according to the currently set operation mode from among the plurality of operation modes. Thus, the image forming apparatus 100 may easily perform operations to be performed by a user, from among a plurality of operations according to functions of the image forming apparatus 100.

FIG. 2 is a block diagram illustrating the image forming apparatus 100 of FIG. 1. Referring to FIG. 2, the image forming apparatus 100 includes an operation mode determination unit 110, a control unit 120, and a user interface unit 160.

FIG. 2 illustrates the image forming apparatus 100 including elements related to FIG. 1, for example. Accordingly, one of ordinary skill in the art would understand that the image forming apparatus 100 may further include various other elements.

The operation mode determination unit 110 and the control unit 120 included in the image forming apparatus 100 of FIG. 2 may correspond to one or more processors. The processor may be configured as an array including a plurality of logic gates or as a combination of a general-purpose microprocessor and a memory storing programs executable in the microprocessor. Also, one of ordinary skill in the art would understand that the processor may be configured as another type of hardware.

A plurality of operation modes may be set in the image forming apparatus 100, for example, and the image forming apparatus 100 may perform one or more operations according to a currently set operation mode from among the plurality of operation modes. Hereinafter, for convenience of description, the operation mode is limited to a scan mode, a printing mode, and a transmission mode. However, one of ordinary skill in the art would understand that the operation mode is not limited thereto and other additional operation modes according to functions of the image forming apparatus 100 may be included.

The user interface unit 160 includes an input button for performing a predetermined operation on image data obtained by capturing from the host device 200, which is connected to the image forming apparatus 100. The input button may be a one-touch button. That is, when a user performs a simple operation of pressing the input button included in the image forming apparatus 100, the image forming apparatus 100 may perform a previously set operation according to a current operation mode.

Hereinafter, the predetermined operation will be described. When a user selects the input button included in the user interface unit 160, the image forming apparatus 100 performs various operations that are previously set by the user or set by default on image data obtained by capturing from the host device 200. The various operations that are previously set by the user or set by default may include one or more operations selected from the group consisting of a printing operation, a storing operation, a transmitting operation, and a scanning operation.

The input button may be distinguished from a start button for performing general operations such as a printing operation, a scanning operation, a transmitting operation, etc. according to an operation mode. However, embodiments are not limited thereto, and one of ordinary skill in the art would understand that if the input button is selected by using the same input button, the image forming apparatus 100 may perform a predetermined operation, according to setting of the image forming apparatus 100 or the host device 200, on image data obtained by capturing from the host device 200, which is connected to the image forming apparatus 100 or perform a predetermined operation according to an operation mode of the image forming apparatus 100, on image data obtained by capturing from the host device 200.

The user interface unit 160 obtains input information from a user and displays output information to the user. For example, the user interface unit 160 includes input-output apparatuses such as a display panel, a mouse, a keyboard, a touch screen, a monitor, a speaker, etc. that are included in the image forming apparatus 100, and a software module for driving those input-output apparatuses.

Accordingly, the user may perform various operations on image data obtained by capturing from the host device 200 in correspondence to a current operation mode of the image forming apparatus 100, only through a simple operation of selecting the input button included in the user interface unit 160.

The control unit 120 determines whether the input button included in the user interface unit 160 is selected by a user. For example, if the input button is pressed by the user, the control unit 120 determines that the input button is selected by the user.

If the control unit 120 determines that the input button is selected by the user, the operation mode determination unit 110 determines a current operation mode of the image forming apparatus 100 from among a plurality of operation modes including a scan mode, a printing mode, and a transmission mode. In this case, the operation mode determination unit 110 may determine the current operation mode of the image forming apparatus 100 with reference to system information of the image forming apparatus 100. The system information includes information regarding a plurality of operation modes that may be set in the image forming apparatus 100, and information regarding the currently set operation mode. The system information may be stored in a storage area in the image forming apparatus 100.

For example, a user may set the operation mode of the image forming apparatus 100 through the user interface unit 160. Thus, information regarding the set operation mode may be stored in a storage unit of the image forming apparatus 100. That is, the information regarding the current operation mode of the image forming apparatus 100 may be stored in an electrically erasable programmable read-only memory (E2PROM), a static random access memory (SRAM), or a flash memory that is an example of a non-volatile memory which is a storage unit. Thus, the operation mode determination unit 110 may determine a current operation mode of the image forming apparatus 100 with reference to information regarding the operation mode stored in the storage unit.

In detail, the image forming apparatus 100 is set to an operation mode according to an operation to be performed in order to perform any one operation from among various operations executable in the image forming apparatus 100.

For example, when the image forming apparatus 100 performs a scanning operation, the image forming apparatus 100 is set to a scan mode. Also, when the image forming apparatus 100 performs a printing operation such as copying or printing-out, the image forming apparatus 100 is set to a printing mode. Also, when the image forming apparatus 100 performs a facsimile transmitting operation or an e-mail transmitting operation, the image forming apparatus 100 is set to a transmission mode.

Thus, the image forming apparatus 100 is set to an operation mode according to an operation to be performed, and the operation mode determination unit 110 determines a current operation mode of the image forming apparatus 100 from among a plurality of operation modes that may be set in the image forming apparatus 100.

Thus, the control unit 120 controls a previously set operation to be performed, in correspondence to the operation mode according to a result of the determining by the operation mode determination unit 110, on image data obtained by capturing from the host device 200, which is connected to the image forming apparatus 100.

The term ‘capture’ refers to converting an image displayed on the host device 200 connected to the image forming apparatus 100, an image included in an activated window, or the like into digitized image data, but the inventive concept is not limited thereto. Thus, at least some of images displayed on the host device 200 may be converted into image data.

In this case, one of ordinary skill in the art would understand that the image displayed on the host device 200 or the image included in the activated window (hereinafter, referred to as an image generated by a host device for convenience of description) may include not only an image displayed on a screen of the host device 200 but also in regions that are not currently displayed on the screen of the host device 200 but that may be displayed by adjusting a size of the screen or by using a scroll-bar.

Also, the image data may be obtained by capturing at least some of images generated by the host device 200. In this case, one of ordinary skill in the art would understand that the at least some of the images generated by the host device 200 may refer to either all or some of the images generated by the host device 200.

The previously set operation may include at least one selected from the group consisting of a printing operation for printing image data, a storing operation for storing image data and a transmitting operation for outputting image data to the external device. Also, the storing operation may be performed to store image data in the external device connected to the external device or in the image forming apparatus 100, and the transmitting operation may be performed to transmit image data to an e-mail server for sending e-mails or to a facsimile apparatus for sending data.

The previously set operation in correspondence to the operation mode of the image forming apparatus 100 is previously set by a user or by default. In this case, the term ‘previously set’ may refer to setting before performing a predetermined operation on image data obtained by capturing from the host device 200.

In addition, the operation previously set in correspondence to an operation mode of the image forming apparatus 100 may be an operation substantially related to an operation mode of the image forming apparatus 100. In this regard, user may easily use the image forming apparatus 100 by understanding instinctively. As such, when a user performs a scanning operation, a storing operation for storing scanned image data should be performed, and thus the storing operation may be previously set in correspondence to a scan mode of the image forming apparatus 100.

In detail, the storing operation may be set in correspondence to the scan mode which is a current operation mode of the image forming apparatus 100, the printing operation may be set in correspondence to a printing mode which is a current operation mode of the image forming apparatus 100, and the transmitting operation may be set in correspondence to a transmission mode which is a current operation mode of the image forming apparatus 100. In this case, when the image forming apparatus 100 is in the scan mode, the storing operation is performed on the image data obtained by capturing from the host device 200. Also, when the image forming apparatus 100 is in the printing mode, the printing operation is performed on the image data obtained by capturing from the host device 200. In addition, when the image forming apparatus 100 is in the transmission mode, the transmitting operation is performed on the image data obtained by capturing from the host device 200.

A case where a current operation mode of the image forming apparatus 100 is a scan mode and an operation previously set in correspondence to the scan mode is a storing operation for storing image data in a USB memory connected to the image forming apparatus 100 will now be described in more detail. If a user selects the input button included in the image forming apparatus 100, the operation mode determination unit 110 determines a current operation mode of the image forming apparatus 100 as a scan mode, and the control unit 120 performs a storing operation previously set in correspondence to an operation mode of the image forming apparatus 100 on the image data obtained by capturing from the host device 200, which is connected to the image forming apparatus 100. Thus, the user may store the image data obtained by capturing from the host device 200 in the USB memory connected to the image forming apparatus 100 only through a simple operation of selecting the input button.

Also, a case where an operation mode of the image forming apparatus 100 is a transmission mode and an operation previously set in correspondence to the transmission mode is an e-mail transmitting operation will now be described in more detail. If a user selects the input button included in the image forming apparatus 100, the operation mode determination unit 110 determines a current operation mode of the image forming apparatus 100 as the transmission mode, and the control unit 120 performs the transmitting operation that is previously set in correspondence to the operation mode of the image forming apparatus 100 on the image data obtained by capturing from the host device 200. Thus, the user may transmit the image data obtained by capturing from the host device 200 to a predetermined e-mail address through a simple operation of selecting the input button.

In this case, the input button included in the image forming apparatus 100 may be an input button for performing predetermined operations on image data obtained by capturing from the host device 200, which is connected to the image forming apparatus 100. Also, the input button may not only be a mechanistic input button type but may also be any of various types that may be selected by a user. In addition, the input button may be included in the host device 200 connected to the image forming apparatus 100.

Thus, the image forming apparatus 100 may perform various operations such as a printing operation, a storing operation, and a transmitting operation on the image data obtained by capturing from the host device 200. Such a plurality of operations may be performed through a simple operation of selecting the input button, and also various operations according to a current operation mode of the image forming apparatus 100 may be performed, thereby increasing user convenience.

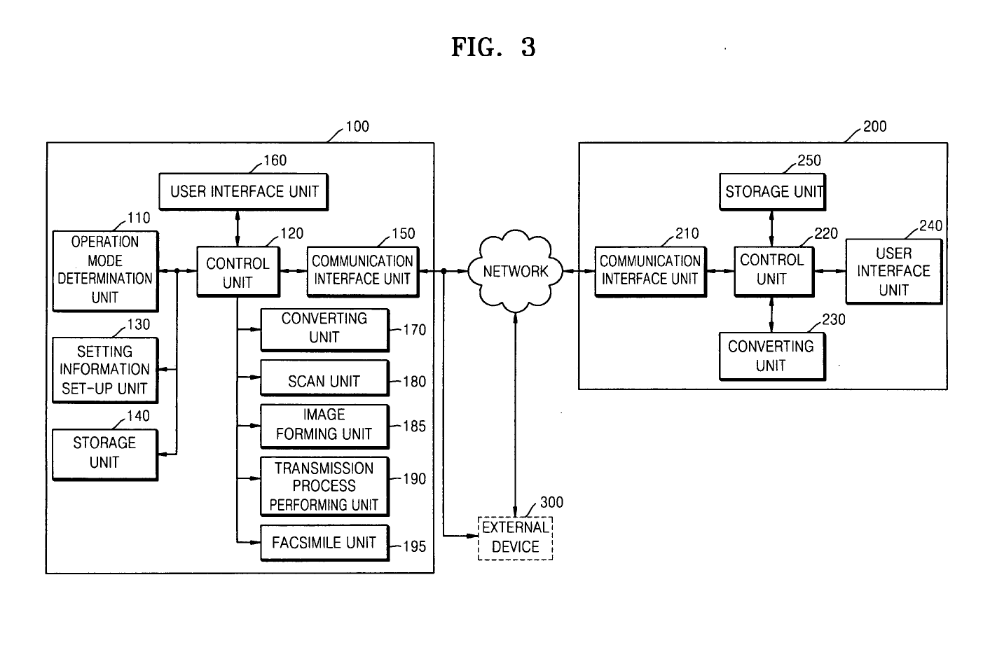

FIG. 3 is a detailed block diagram illustrating the image forming apparatus 100, the host device 200, and the external device 300, according to an embodiment of the inventive concept. Referring to FIG. 3, the image forming apparatus 100 includes the operation mode determination unit 110, the control unit 120, a setting information set-up unit 130, a storage unit 140, a communication interface unit 150, the user interface unit 160, the converting unit 170, a scan unit 180, an image forming unit 185, a transmission process performing unit 190, and a facsimile unit 195. The host device 200 includes a communication interface unit 210, a control unit 220, a converting unit 230, a user interface unit 240, and a storage unit 250.

FIG. 3 illustrates the image forming apparatus 100 and the host device 200 including elements related to FIG. 1, for example. Accordingly, one of ordinary skill in the art would understand that the image forming apparatus 100 and the host device 200 may further include various other elements.

The image forming apparatus 100, the host device 200, and the external device 300 illustrated in FIG. 3 correspond to those illustrated in FIGS. 1 and 2. Thus, the image forming apparatus 100 and the host device 200 are not limited to the elements illustrated in FIG. 3. Also, descriptions regarding FIGS. 1 and 2 may be applied to the image forming apparatus 100, the host device 200, and the external device 300 illustrated in FIG. 3, and thus repeated descriptions thereof will be omitted here.

Referring to FIG. 3, the operation mode determination unit 110, the control unit 120, the setting information set-up unit 130, the converting unit 170, and the transmission process performing unit 190 included in the image forming apparatus 100 which are illustrated in FIG. 3 and the control unit 220 and the converting unit 230 included in the host device 200 which are illustrated in FIG. 3 may correspond to one or more processors.

A plurality of operation modes may be set in the image forming apparatus 100, and the image forming apparatus 100 may perform one or more operations according to a currently set operation mode from among the plurality of operation modes.

The operation mode determination unit 110 determines a current operation mode of the image forming apparatus 100 from among the plurality of operation modes that may be set in the image forming apparatus 100. The control unit 120 controls the overall function of the image forming apparatus 100, and also controls a previously set operation to be performed, in correspondence to the operation mode according to a result of the determining of the operation mode determination unit 110, on image data obtained by capturing from the host device 200, which is connected to the image forming apparatus 100.

In this case, the previously set operation to be performed under the control of the control unit 120 may be a printing operation for printing image data, a storing operation for storing image data in any one of the image forming apparatus 100 or the external device 300, and a transmitting operation for transmitting image data to the external device 300.

When the input button included in the image forming apparatus 100 is selected, the control unit 120 controls each element included in the image forming apparatus 100 so as to perform an operation previously set in correspondence to a current operation mode of the image forming apparatus 100.

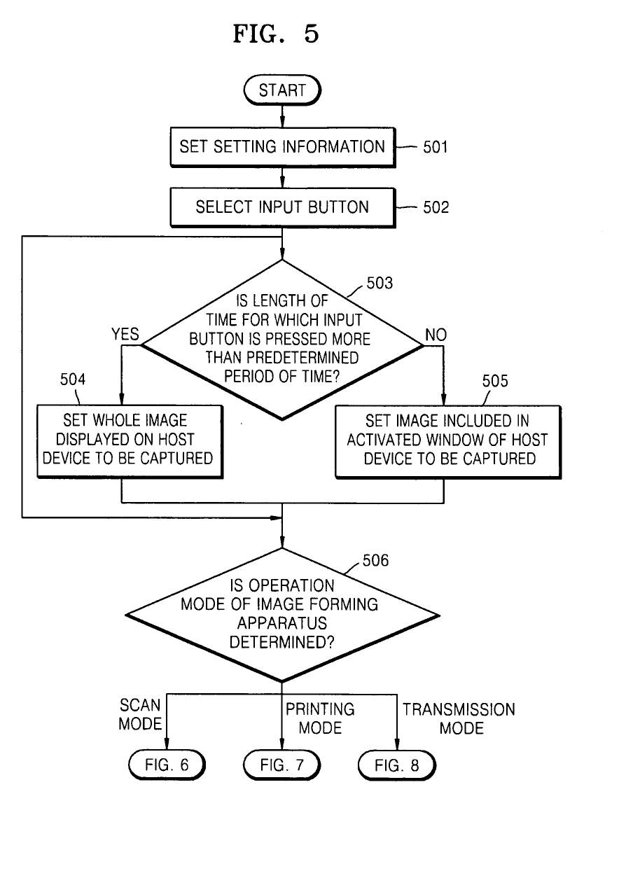

Various embodiments for performing an operation previously set in correspondence to a current operation mode of the image forming apparatus 100 will now be described in detail with reference to FIGS. 5 through 8.

The setting information set-up unit 130 sets at least one selected from the group consisting of an operation to be performed in correspondence to an operation mode of the image forming apparatus 100, a capture range in the host device 200, and a format of captured image data. In this case, information input by a user may be directly input by the user through the user interface unit 160, or information input to the host device 200 may be input through the communication interface unit 150.

Setting of an operation to be performed in correspondence to an operation mode of the image forming apparatus 100 by the setting information set-up unit 130 refers that the setting information set-up unit 130 sets an operation to be performed in correspondence to each of a scan mode, a printing mode, and a transmission mode that may be set in the image forming apparatus 100. In this case, the operations to be performed in correspondence to each of the plurality of operation modes may include an operation for storing image data in a predetermined storage location, an operation for printing image data according to predetermined setting information, and an operation for transmitting image data to a predetermined receiving location via a facsimile or email. However, as described above, the operation to be performed in correspondence to an operation mode of the image forming apparatus 100 may be set as an operation that is substantially related to the operation mode.

Setting of the capture range in the host device 200 by the setting information set-up unit 130 refers to setting a range in which any image is captured from among images generated by the host device 200 and is converted into image data. For example, the capture range in the host device 200 may be a whole image displayed on the host device 200, a whole image included in an activated window of the host device 200, or an image included in an area designated by a user in the host device 200.

In addition, the setting information set-up unit 130 may be set so that a capture range with respect to an image generated by the host device 200 is determined according to how long the input button included in the image forming apparatus 100 is pressed by a user.

For example, when a user presses the input button included in the image forming apparatus 100 for a long time, the setting information set-up unit 130 may be set so that a whole image displayed on the host device 200 is captured. When a user presses the input button included in the image forming apparatus 100 for a short time, the setting information set-up unit 130 may be set so that an image included in an activated window in the host device 200 is captured.

The cases where the user presses the input button for a long time or for a short time may be determined according to whether the time for which the input button is pressed by the user is longer than a predetermined period of time. For example, the predetermined period of time may be one second, but the inventive concept is not limited thereto. The control unit 120 determines whether the user presses the input button for a long time or for a short time, according to whether the length of time the input button is pressed by the user is longer than the predetermined period of time.

A case where the setting information set-up unit 130 sets a format of image data obtained by capturing from the host device 200 will now be described. For example, the setting information set-up unit 130 may set the format of the image data obtained by capturing from the host device 200 by converting the format of the image data into a joint photographic coding experts group (JPEG) format, a portable document format (PDF) format, a tagged image file format (TIFF) format, or the like. In this case, the converting of the format of the image data may be performed in any one of the converting unit 170 of the image forming apparatus 100 or the converting unit 230 of the host device 200.

Also, the setting information set-up unit 130 may set setting information with respect to each of previously set operations.

A case where an operation mode of the image forming apparatus 100 is a scan mode and an operation previously set in correspondence to the scan mode is a storing operation will now be described. For example, the setting information set-up unit 130 may set a location where image data, which is obtained by capturing from the host device 200, is to be stored and a format in which the image data is to be stored, with reference to information input by a user.

In this case, the location where the image data is to be stored may be the storage unit 140 in the image forming apparatus 100 or the external device 300 connected to the image forming apparatus 100.

When the location where the image data is to be stored is set to the storage unit 140 in the image forming apparatus 100, the setting information set-up unit 130 may set a route according to a storage location, such as a document box name, a folder name, or the like, in the storage unit 140.

When the storage location where the image data is to be stored is set to the external device 300 connected to the image forming apparatus 100, the setting information set-up unit 130 may set a route according to a storage location, such as a name or a type of the external device 300. Also, when the storage location where the image data is to be stored is connected via a network as a server apparatus, which is an example of the external device 300, the setting information set-up unit 130 may additionally set information, for example, about an internet protocol (IP) address

The format in which the image data is to be stored may be set to a JPEG, PDF, TIFF format, or the like. In this case, when a format of image data received from the host device 200 is not the set format, the converting unit 170 converts the format of the image data into the set format.

Another case where an operation mode of the image forming apparatus 100 is a transmission mode and an operation previously set in correspondence to the transmission mode is a transmitting operation will now be described. The setting information set-up unit 130 may set a method in which the image data received from the host device 200 is to be transmitted and a receiving location where the image data is to be received, with reference to information input by a user.

The method in which the image data is to be transmitted may be at least one selected from the group consisting of a facsimile transmitting method and an e-mail transmitting method. Thus, when the method in which the image data is to be transmitted is set to the facsimile transmitting method, the receiving location where the image data is to be received may be a receiving fax number. When the method in which the image data is to be transmitted is set to the e-mail transmitting method, the receiving location where the image data is to be received may be a receiving e-mail address.

A facsimile transmitting operation will now be described in detail. After a user inputs a receiving fax number through the user interface unit 160, when the user presses an input button for transmitting image data, which was obtained by capturing from the host device 200, via facsimile, the image data received from the host device 200 is transmitted to a fax number that is input by the user.

However, when the user does not input the receiving fax number and presses the input button, the image data received from the host device 200 may be transmitted to a receiving fax number that is set by default by the setting information set-up unit 130, or a message indicating that a receiving fax number is not input by the user may be output.

An e-mail transmitting operation will now be described in detail. After a user inputs a receiving e-mail address through the user interface unit 160, when the user presses an input button for transmitting image data obtained by capturing from the host device 200, the image data received from the host device 200 may be transmitted to the receiving e-mail address that is input by the user.

However, if the user does not input the receiving e-mail address and presses the input button, the image data received from the host device 200 may be transmitted to a receiving e-mail address that is set by default by the setting information set-up unit 130, or a message indicating that a receiving e-mail address is not input by the user may be output.

Another case where an operation mode of the image forming apparatus 100 is a printing mode and an operation previously set in correspondence to the printing mode is a printing operation will now be described in detail. When image data received from the host device 200 is not printed in a piece of printing paper, the setting information set-up unit 130 may set the image data to be downsized or to be divided.

When the image data is set to be downsized, the control unit 120 controls the image data to be downsized and printed on a piece of printing paper according to the setting of the setting information set-up unit 130. When the image data is set to be divided, the control unit 120 controls the image data to be divided and printed in a plurality pieces of printing papers according to the setting of the setting information set-up unit 130.

Setting information set by the setting information set-up unit 130 according to the above description may be stored in the storage unit 140 of the image forming apparatus 100. Also, the setting information may be set with respect to each of a plurality of users using the image forming apparatus 100, and an operation according to the setting information that is set for each user may be performed in correspondence to certification information of each user.

Thus, a user may easily set various setting information in the image forming apparatus 100 or the host device 200. The image forming apparatus 100 may allow various operations to be performed only through a simple operation with reference to the set setting information.

The storage unit 140 stores data for performing operations in the image forming apparatus 100 and data generated by performing operations in the image forming apparatus 100. The storage unit 140 may store setting information set by the setting information set-up unit 130 and store image data obtained by capturing from the host device 200.

The storage unit 140, which is a general storage medium, may include a hard disk drive (HDD), a mass storage read only memory (ROM), a random access memory (RAM), a flash memory, a memory card, and a solid state drive (SSD).

The communication interface unit 150 sends/receives data to/from at least one of the host device 200 and external device 300. Thus, the control unit 120 requests the host device 200 for image data according to setting of the setting information set-up unit 130 through the communication interface unit 150. In addition, the control unit 120 controls an operation previously set in correspondence to an operation mode according to a result of the determining of the operation mode determination unit 110 to be performed on the image data received through the communication interface unit 150 as a response to the request.

The communication interface unit 150 may include a modem used for facsimile sending/receiving, a network module for accessing a network, a USB host module for forming a channel for sending/receiving data to/from a portable storage medium according to a function of the image forming apparatus 100.

In addition, the communication interface unit 150 may send/receive data to/from a server apparatus, which is an example of the external device 300, by using a file sharing protocol, for example, a network file system (NFS) or a common internet file system (CIFS). One of ordinary skill in the art would know the file sharing protocol, and thus a detailed description thereof will be omitted.

The user interface unit 160 obtains input information from a user and displays out information to the user. Also, a user may set setting information by manipulating the user interface unit 160 and may store the setting information in the storage unit 140.

In addition, as described above, a capture range with respect to an image generated by the host device 200 may be set according to how long the input button included in the user interface unit 160 is pressed by a user.

Accordingly, the user may perform various operations in correspondence to a current operation mode of the image forming apparatus 100 on image data obtained by capturing from the host device 200 only by performing a simple operation of pressing the input button included in the user interface unit 160.

The converting unit 170 converts a format of the image data received from the host device 200 into a format according to the setting of the setting information set-up unit 130. In detail, the converting unit 170 converts the format of the image data into a format suitable for performing an operation previously set in correspondence to the current operation mode of the image forming apparatus 100. However, when the host device 200 converts the format of the image data into a format suitable for performing an operation previously set and transmits the converted image data to the image forming apparatus 100, the converting unit 170 included in the image forming apparatus 100 may not operate.

A case where image data is to be transmitted via a facsimile according to a setting of the setting information set-up unit 130 will be described. In this case, when the image data received from the host device 200 has a bitmap format, the converting unit 170 converts the bitmap format into a modified MR (MMR) format or a T4 format for sending the image data via facsimile. However, when the host device 200 converts the bitmap format into the modified MR (MMR) format or the T4 format for sending the image data via a facsimile and transmits the converted image data to the image forming apparatus 100, the converting unit 170 included in the image forming apparatus 100 may not operate.

Accordingly, even though a converting operation is not performed in the host device 200, the image forming apparatus 100 may internally perform a converting operation to perform various operations. Thus, when the image forming apparatus 100 is controlled by using a digital apparatus, such as a personal digital assistant (PDA) which is an example of the host device 200, various operations according to an operation mode of the image forming apparatus 100 may be easily performed regardless of a performance and a capacity of the host device 200.

The scan unit 180 performs a scanning operation for obtaining image data by scanning a copy. The scan unit 180 includes hardware units for performing a scanning operation such as a light-emitting device and an image sensor, and a software module for driving the hardware units. When the image forming apparatus 100 performs a scanning operation through the scan unit 180, an operation mode of the image forming apparatus 100 is set to a scan mode.

The image forming unit 185 performs a printing operation for printing image data on a printing paper. The image forming unit 185 includes hardware units for performing electric charging, exposing, developing, transfer, and fixing, and a software module for driving these operations. When the image forming apparatus 100 performs a printing operation through the image forming unit 185, an operation mode of the image forming apparatus 100 is set to a printing mode.

The transmission process performing unit 190 performs a transmitting operation for transmitting transmission data to the external device 300. The transmission process performing unit 190 performs data processing for performing various transmitting operations. For example, the transmission process performing unit 190 may perform data processing for transmitting e-mails, for storing in the external device 300, and the like. When the image forming apparatus 100 performs a transmitting operation through the transmission process performing unit 190, an operation mode of the image forming apparatus 100 is set to a transmission mode.

The facsimile unit 195 performs a facsimile transmitting operation for transmitting transmission data to a facsimile which is an example of the external device 300. The facsimile unit 195 may perform data processing for transmitting faxes. When the image forming apparatus 100 performs a facsimile transmitting operation through the facsimile unit 195, an operation mode of the image forming apparatus 100 is set to a transmission mode.

Thus, various operations may be performed on image data obtained by capturing from the host device 200 only by simply selecting the input button included in the image forming apparatus 100. Also, operations previously set according to a current operation mode of the image forming apparatus 100 are performed, and thus the image forming apparatus 100 performs the operations according to the currently performed operation on the image data obtained by capturing from the host device 200. Accordingly, a user may intuitionally and easily perform multiple functions of the image forming apparatus 100.

The host device 200 includes the communication interface unit 210, the control unit 220, the converting unit 230, the user interface unit 240, and the storage unit 250. The host device 200 provides captured image data to the image forming apparatus 100 according to a request of the image forming apparatus 100.

The communication interface unit 210 sends/receives data to/from the image forming apparatus 100 via a network.

The communication interface unit 210 receives a request to image data from the image forming apparatus 100. In this case, the request to the image data may further include setting information set in the image forming apparatus 100. The setting information set in the image forming apparatus 100 may include, for example, information regarding a capture range of an image generated by the host device 200 and a format of captured image data. Also, the communication interface unit 210 sends the image data according to the request to the image forming apparatus 100 as a response with response to the request.

The control unit 220 controls general operations of the host device 200. The control unit 220 also captures the image generated by the host device 200 and converts the image into image data. In this case, the control unit 220 may capture the image generated by the host device 200 according to the capture range on the basis of setting information and may convert the image into image data, with reference to the request received from the image forming apparatus 100.

The converting unit 230 converts the image data obtained by the control unit 220 into a format of image data according to setting information. For example, the converting unit 230 may convert image data having a bitmap format into image data having a format, such as a printer command language (PCL) format, a graphics device interface (GDI) format, or an MMR format, according to setting information.

The user interface unit 240 obtains input information from a user and displays output information to the user. For example, the user interface unit 240 includes input/output apparatuses, such as a display panel, a mouse, a keyboard, a touch screen, a monitor, a speaker, etc., included in the host device 200, and a software module for driving the input/output apparatuses. A user may set setting information by manipulating the user interface unit 240 according to a web user interface (UI) function, and the set setting information may be transmitted to the image forming apparatus 100.

The storage unit 250 stores data for performing functions of the host device 200 and data generated by performing the functions in the host device 200. The storage unit 250, which is a general storage medium, may include an HDD, a ROM, a RAM, a flash memory, a memory card, or a solid state drive (SSD).

Thus, a user may easily perform a storing operation, a transmitting operation, etc. on image data obtained by capturing from the host device 200, only through a simple manipulation by using the image forming apparatus 100 and the host device 200 connected to the image forming apparatus 100.

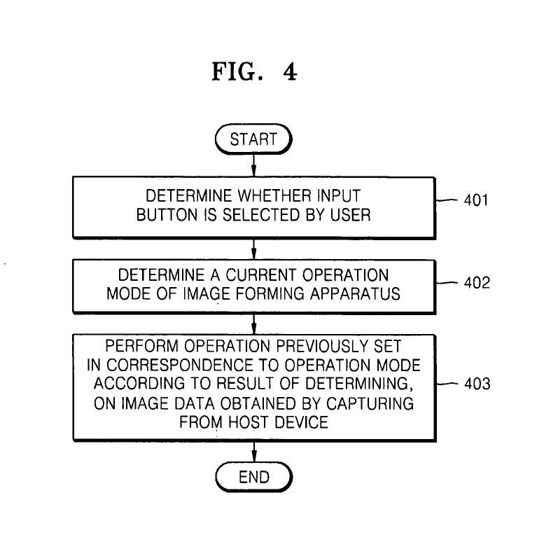

FIGS. 4 through 9 are flowcharts illustrating a method of performing operations in the image forming apparatus 100, according to an embodiment of the inventive concept. Referring to FIGS. 4 through 9, the method includes operations that are sequentially processed in the image forming apparatus 100, the host device 200, and the external device 300 illustrated in FIGS. 1 through 3. Accordingly, even though omitted below, the above description with regard to the image forming apparatus 100, the host device 200, and the external device 300 illustrated in FIGS. 1 through 3 may also be applied to the method illustrated in FIGS. 4 through 9.

FIG. 4 is a flowchart illustrating the method of performing operations in the image forming apparatus 100, according to an embodiment of the inventive concept. In this case, a plurality of operation modes may be set in the image forming apparatus 100.

In operation 401, the control unit 120 determines whether a user selects an input button for performing a predetermined operation on image data obtained by capturing from the host device 200, which is connected to the image forming apparatus 100. In this case, the predetermined operation may be any of various operations according to a function of the image forming apparatus 100, and may be determined according to a setting of the above-described setting information set-up unit 130.

In operation 402, the control unit 120 determines that the input button is selected by the user according to a result of the determining, the operation mode determination unit 110 determines a current operation mode of the image forming apparatus 100 from among a plurality of operation modes.

In operation 403, the control unit 120 controls operations, which were previously set in correspondence to the operation mode according to a result of the determining in operation 402, to be performed on the image data obtained by capturing from the host device 200, which is connected to the image forming apparatus 100.

Thus, the user may easily perform the operations, which were previously set in correspondence to the current operation mode of the image forming apparatus 100, on the image data obtained by capturing from the host device 200.

FIG. 5 is a flowchart illustrating a method of setting-up setting information in the image forming apparatus 100 and of determining an operation mode, according to an embodiment of the inventive concept.

In operation 501, the setting information set-up unit 130 sets setting information with reference to information input by a user. The setting information set by the setting information set-up unit 130 may be stored in the storage unit 140. In this case, the setting information may include an operation to be performed in correspondence to an operation mode of the image forming apparatus 100, a capture range of image data, a format of captured image data, and the like.

For example, when an operation mode of the image forming apparatus 100 is a scan mode, a user may set a storing operation to be performed in correspondence to the scan mode, and may also set a capture range of an image generated by the host device 200, a storage location where image data is to be stored, and a format of the image data.

Alternatively, when an operation mode of the image forming apparatus 100 is a printing mode, a user may set a printing operation to be performed in correspondence to the printing mode. Also, when a capture range of an image generated by the host device 200 and image data is not printed on one printing paper, the user may set the image data to be downsized or divided.

Alternatively, when an operation mode of the image forming apparatus 100 is a transmission mode, a user may set a transmitting operation to be performed in correspondence to the transmission mode, and may also set a capture range of an image generated by the host device 200, a method in which image data is to be transmitted, and a receiving location where the image data is to be received.

In operation 502, the user selects an input button included in the image forming apparatus 100.

If a capture range is set to be determined according to how long the input button included in the image forming apparatus 100 is pressed by a user in connection with a capture range of image data, the following operations 503 through 505 are performed, and if not, operations 503 through 505 are not performed, and operation 506 may be directly performed.

In operation 503, the control unit 120 determines whether the length of time for which the input button is pressed is more than a predetermined period of time. According to a result of the determining, if the length of time for which the input button is pressed is more than the predetermined period of time, the method proceeds to operation 504, or if the length of time for which the input button is pressed is less than the predetermined period of time, the method proceeds to operation 505.

In operation 504, the setting information set-up unit 130 sets a whole image displayed on the host device 200 to be captured. In operation 505, the setting information set-up unit 130 sets an image included in an activated window of the host device 200 to be captured.

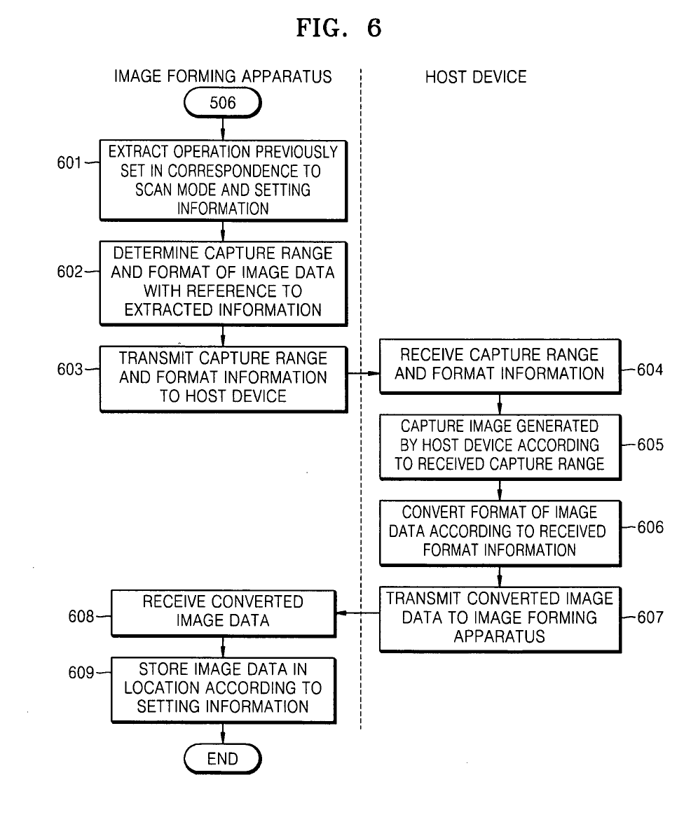

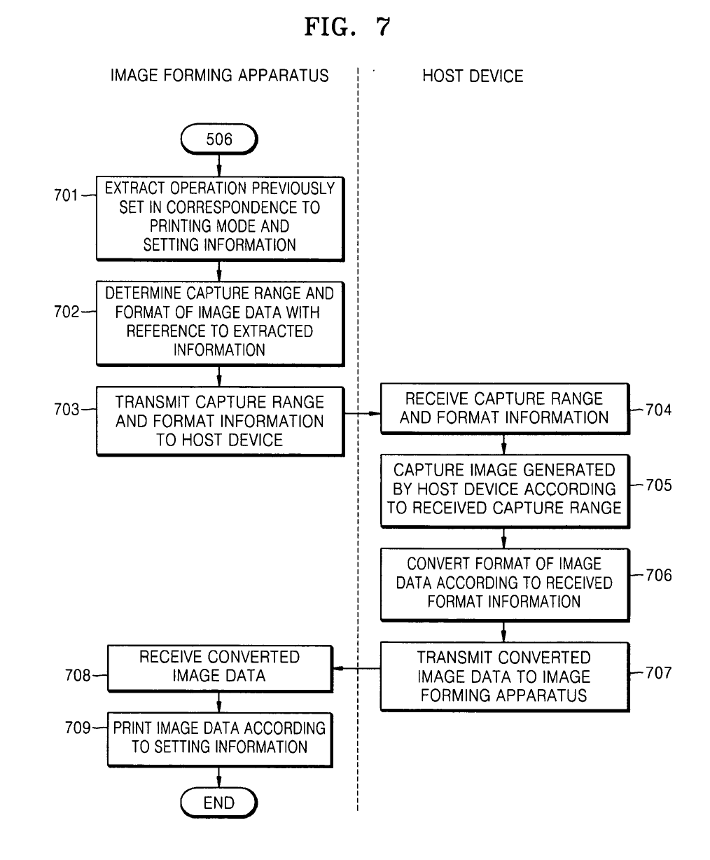

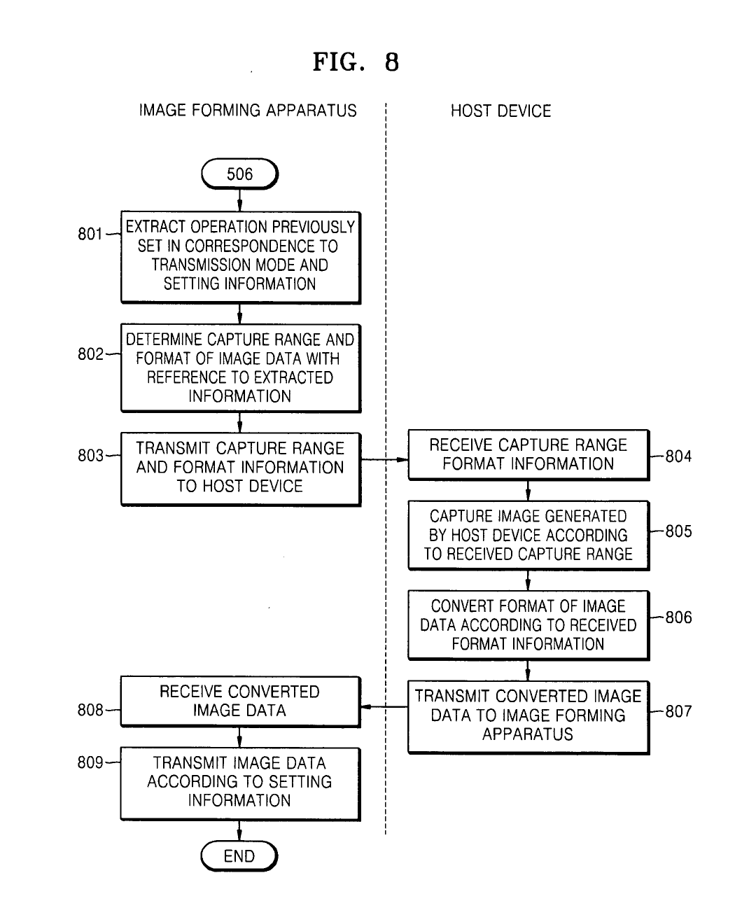

In operation 506, the operation mode determination unit 110 determines an operation mode of the image forming apparatus 100. According to a result of the determining, if the operation mode of the image forming apparatus 100 is a scan mode, the method proceeds to the method illustrated in FIG. 6, if the operation mode of the image forming apparatus 100 is a printing mode, the method proceeds to the method illustrated in FIG. 7, or if the operation mode of the image forming apparatus 100 is a transmission mode, the method proceeds to the method illustrated in FIG. 8.

FIG. 6 is a flowchart illustrating data-flow between the image forming apparatus 100 and the host device 200, when the image forming apparatus 100 is in the scan mode, according to an embodiment of the inventive concept.

In operation 601, the control unit 120 of the image forming apparatus 100 extracts an operation previously set in correspondence to a scan mode and setting information according to the set operation from the storage unit 140.

For example, the operation previously set in correspondence to the scan mode may be a storing operation, and the setting information according to the storing operation may be set so that a whole image displayed on the host device 200 is captured and so that image data is stored in a USB memory, which is an example of the external device 300 connected to the image forming apparatus 100, in a JPEG format.

In operation 602, the control unit 120 of the image forming apparatus 100 determines a capture range of an image generated by the host device 200 and a format of image data to be stored, with reference to the information extracted in operation 601. As described above, the capture range may be the whole image displayed on the host device 200, and the format of the image data may be a JPEG format.

In operation 603, the communication interface unit 150 of the image forming apparatus 100 transmits the capture range and the format information determined in operation 602 to the host device 200.

However, according to a usage environment, the image forming apparatus 100 may generate an event for checking whether the host device 200 normally operates, and the host device 200 may transmit an ACK message as a response with respect to the event generated by the image forming apparatus 100 to the image forming apparatus 100. Thus, if the ACK message arrives from the host device 200 within a predetermined period of time, the image forming apparatus 100 determines that the host device 200 is normally operating, and operation 603 is performed. However, if the ACK message does not arrive from the host device 200 within a predetermined period of time, the image forming apparatus 100 notifies a user that the host device 200 does not operate normally, and the method ends.

In operation 604, the communication interface unit 210 of the host device 200 receives a capture range and format information from the image forming apparatus 100.

In operation 605, the control unit 220 of the host device 200 captures an image generated by the host device 200 according to the received capture range. For example, the control unit 220 obtains image data by capturing a whole image displayed on the host device 200.

In operation 606, the converting unit 230 of the host device 200 converts a format of the obtained image data according to the received format information. For example, when the obtained image data has a bitmap (BMP) format, the converting unit 230 may convert the BMP format of the image data into a JPEG format.

However, according a usage environment, the converting operation may be performed by the converting unit 170 of the image forming apparatus 100. When the converting operation is performed by the converting unit 170 of the image forming apparatus 100, operation 606 illustrated in FIG. 6 may not be performed, and the converting operation of the image data may be performed by the converting unit 170 of the image forming apparatus 100 between operation 608 and operation 609.

In operation 607, the communication interface unit 210 of the host device 200 transmits the image data converted in operation 606 to the image forming apparatus 100. In operation 608, the communication interface unit 150 of the image forming apparatus 100 receives the converted image data from the host device 200.

However, according to a usage environment, if image data is not received from the host device 200 within a predetermined period of time, the image forming apparatus 100 notifies a user that the host device 200 does not operate normally, and the method ends.

In operation 609, the control unit 120 of the image forming apparatus 100 controls the image data received in operation 608 to be stored in a location according to setting information. For example, the control unit 120 controls image data to be transmitted to the USB memory via the communication interface unit 150 and to be stored in the USB memory connected to the image forming apparatus 100.

Thus, when an operation mode of the image forming apparatus 100 is a scan mode, the image data obtained by capturing from the host device 200 may be stored by performing a simple operation of selecting the input button included in the image forming apparatus 100.

FIG. 7 is a flowchart illustrating data-flow between the image forming apparatus 100 and the host device 200, when the image forming apparatus 100 is in a printing mode, according to an embodiment of the inventive concept.

The flowchart illustrated in FIG. 7 is the same as that illustrated in FIG. 6 except that the image forming apparatus 100 is in the printing mode, and thus a detailed description thereof will be omitted here.

In operation 701, the control unit 120 of the image forming apparatus 100 extracts an operation previously set in correspondence to the printing mode and setting information according to the set operation from the storage unit 140.

For example, the operation previously set in correspondence to the printing mode may be a printing operation, and the setting information according to the printing operation may be set so that an image included in an activated window of the host device 200 is captured and so that image data is downsized when image data is not printed on one printing paper.

In operation 702, the control unit 120 of the image forming apparatus 100 determines a capture range of an image generated by the host device 200 and a format of image data, with reference to the information extracted in operation 701. As described above, the capture range may be the image included in the activated window of the host device 200, and the format of the image data may be a PCL or GDI format for performing the printing operation.

In operation 703, the communication interface unit 150 of the image forming apparatus 100 transmits the capture range and the format information determined in operation 702 to the host device 200. In operation 704, the communication interface unit 210 of the host device 200 receives the capture range and the format information from the image forming apparatus 100.

In operation 705, the control unit 220 of the host device 200 captures an image generated by the host device 200 according to the received capture range. For example, the control unit 220 obtains image data by capturing an image included in an activated window of the host device 200.

In operation 706, the converting unit 230 of the host device 200 converts a format of the obtained image data according to the received format information. For example, when the obtained image data has a BMP format, the converting unit 230 converts the BMP format of the obtained image data into a PCL format.

However, according to a usage environment, the converting operation may be performed by the converting unit 170 of the image forming apparatus 100. When the converting operation is performed by the converting unit 170 of the image forming apparatus 100, operation 706 illustrated in FIG. 7 may not be performed, and the converting operation of the image data may be performed by the converting unit 170 of the image forming apparatus 100 between operation 708 and operation 709.

In operation 707, the communication interface unit 210 of the host device 200 transmits the image data converted in operation 706 to the image forming apparatus 100. In operation 708, the communication interface unit 150 of the image forming apparatus 100 receives the converted image data from the host device 200.

In operation 709, the control unit 120 of the image forming apparatus 100 controls the image data received in operation 708 to be printed according to setting information. For example, when image data is over-sized and thus is not printed on one printing paper, the control unit 120 may downsizes the image data and print the image data on one printing paper.

In this case, the downsizing operation of the image data may be performed by the control unit 120 of the image forming apparatus 100. However, the inventive concept is not limited thereto, and the downsizing operation of the image data may be performed by the control unit 220 of the host device 200.

Thus, when an operation mode of the image forming apparatus 100 is a printing mode, image data obtained by capturing from the host device 200 may be printed by performing a simple operation of selecting the input button included in the image forming apparatus 100.

FIG. 8 is a flowchart illustrating data-flow between the image forming apparatus 100 and the host device 200, when the image forming apparatus 100 is in a transmission mode, according to an embodiment of the inventive concept.

The flowchart illustrated in FIG. 8 is the same as that illustrated in FIG. 6 except that the image forming apparatus 100 is in the transmission mode, and thus a detailed description thereof will be omitted here.

In operation 801, the control unit 120 of the image forming apparatus 100 extracts an operation previously set in correspondence to the transmission mode and setting information according to the set operation from the storage unit 140.

For example, the operation previously set in correspondence to the transmission mode may be a transmitting operation, and the setting information according to the transmitting operation may be set so that an image included in an activated window of the host device 200 may be captured, image data may be transmitted via facsimile, and a receiving fax number with respect to a receiving location where the image data is to be received may be set.

In operation 802, the control unit 120 of the image forming apparatus 100 determines a capture range of an image generated by the host device 200 and a format of image data, with reference to the information extracted in operation 801. As described above, the capture range is an image included in an activated window of the host device 200, and the format of the image data may be a T4 format or an MMR format for performing a facsimile transmitting operation.

In operation 803, the communication interface unit 150 of the image forming apparatus 100 transmits the capture range and the format information determined in operation 802 to the host device 200. In operation 804, the communication interface unit 210 of the host device 200 receives the capture range and the format information from the image forming apparatus 100.

In operation 805, the control unit 220 of the host device 200 captures an image generated by the host device 200 according to the received capture range. In operation 806, the converting unit 230 of the host device 200 converts a format of image data obtained by capturing an image according to the received format information. For example, when the obtained image data has a BMP format, the converting unit 230 converts the format of the image data into an MMR format.

However, according to a usage environment, the converting operation of the image data may be performed by the converting unit 170 of the image forming apparatus 100. When the converting operation of the image data is performed by the converting unit 170 of the image forming apparatus 100, operation 806 illustrated in FIG. 8 may not be performed, and the converting operation of the image data may be performed by the converting unit 170 of the image forming apparatus 100 between operation 808 and operation 809.

In operation 807, the communication interface unit 210 of the host device 200 transmits the image data converted in operation 806 to the image forming apparatus 100. In operation 808, the communication interface unit 150 of the image forming apparatus 100 receives the converted image data from the host device 200.

In operation 809, the control unit 120 of the image forming apparatus 100 controls the image data received in operation 808 to be transmitted according to setting information. For example, the control unit 120 transmits image data to the set receiving fax number.

Thus, when an operation mode of the image forming apparatus 100 is a transmission mode, the image data obtained by capturing from the host device 200 may be transmitted via a facsimile by performing a simple operation of selecting the input button included in the image forming apparatus 100.

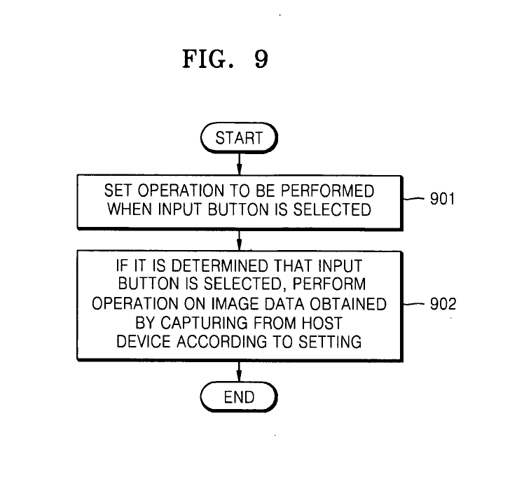

FIG. 9 is a flowchart illustrating a method of performing operations in the image forming apparatus 100, according to another embodiment of the inventive concept.

In operation 901, the setting information set-up unit 130 sets an operation to be performed when the input button included in the image forming apparatus 100 is selected.

In operation 902, if it is determined that the input button included in the image forming apparatus 100 is selected, the control unit 120 controls the operation set in operation 901 to be performed on the image data obtained by capturing from the host device 200, which is connected to the image forming apparatus 100. In this case, the operation may be at least one of a storing operation for storing image data and a transmitting operation for transmitting image data to the external device 300. The storing operation is performed to store image data in at least one of the image forming apparatus 100 and the external device 300.

In this case, the operation mode determination unit 110 may not be included in the image forming apparatus 100. That is, referring to the flowchart illustrated in FIG. 9, an operation set by a user may be performed on the image data obtained by capturing from the host device 200, regardless of a current operation mode of the image forming apparatus 100. Thus, the user may easily perform an operation frequently performed on the image data obtained by capturing from the host device 200, by previously setting the operation frequently performed.

According to the image forming apparatus 100, the user may perform an operation according to the current operation mode of the image forming apparatus 100 on the image data obtained by capturing from the host device 200, only by performing a simple operation of selecting the input button included in the image forming apparatus 100. Thus, the user may easily use the obtained image data in various ways.

According to an image forming apparatus of the inventive concept, a user may easily perform various operations on image data obtained by capturing from a host device. Also, previously set operations are performed according to an operation mode of the image forming apparatus, and thus the user may expand the use range with respect to the obtained image data.

The above-described embodiments may be recorded in computer-readable media including computer-readable instructions to implement various operations embodied by a computer. The media may also include, alone or in combination with the computer readable instructions, data files, data structures, and the like. The computer-readable instructions recorded on the media may be those specially designed and constructed for the purposes of embodiments, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform computer readable instructions, such as read-only memory (ROM), random access memory (RAM), flash memory, and the like. The computer-readable media may also be a distributed network, so that the computer readable instructions are stored and executed in a distributed fashion. The computer readable instructions may be executed by one or more processors. The computer-readable media may also be embodied in at least one application specific integrated circuit (ASIC) or Field Programmable Gate Array (FPGA), which executes (processes like a processor) computer readable instructions. Examples of computer readable instructions include both machine code, such as produced by a compiler, and files containing higher level code that may be executed by the computer using an interpreter. The above-described devices may be configured to act as one or more software modules in order to perform the operations of the above-described embodiments, or vice versa.

Although a few embodiments have been shown and described, it will be appreciated by those skilled in the art that changes may be made in these embodiments without departing from the principles and spirit of the disclosure, the scope of which is defined in the appended claims and their equivalents.

What is claimed is:

1. A method of performing operations in an image forming apparatus in which a plurality of operation modes may be set, the method comprising:
determining whether a user selects an input button for performing a predetermined operation on image data obtained by capturing from a host device connected to the image forming apparatus;
if it is determined that the input button is selected, determining a current operation mode of the image forming apparatus from among the plurality of operation modes; and
performing an operation, which was previously set in correspondence to the operation mode, on the image data, according to a result of the determining.

2. The method of claim 1, wherein the previously set operation comprises at least one of a storing operation for storing the image data and a transmitting operation for transmitting the image data to an external device.

3. The method of claim 1, further comprising setting at least one selected from the group consisting of an operation to be performed in correspondence to the operation mode, a capture range in the host device, and a format of the obtained image data.

4. The method of claim 3, further comprising:
requesting the host device for image data according to the setting; and
receiving image data according to the requesting from the host device,
wherein the performing of the operation comprises performing the operation, which was previously set in correspondence to the operation mode, on the received image data, according to a result of the determining.

5. The method of claim 3, wherein the setting of the capture range in the host device comprises setting the capture range according to a length of time the input button included in the image forming apparatus is pressed by a user.

6. The method of claim 1, wherein the performing of the operation comprises performing a storing operation on the image data, when the operation mode of the image forming apparatus is determined to be a scan mode.

7. The method of claim 6, further comprising:
setting a storage location where the image data is to be stored and a format in which the image data is to be stored;
converting a format of the image data into the set format with reference to the setting; and
storing the converted image data in at least one of the image forming apparatus and an external device with reference to the setting.

8. The method of claim 1, wherein the performing of the operation comprises performing a transmitting operation on the image data, when the operation mode of the image forming apparatus is determined to be a transmission mode.

9. The method of claim 8, further comprising:
setting a method in which the image data is to be transmitted and a receiving location where the image data is to be received;
converting a format of the image data into a format according to the method in which the image data is to be transmitted, with reference to the setting; and
transmitting the converted image data to the receiving location with reference to the setting.

10. The method of claim 1, wherein the performing of the operation comprises performing a printing operation on the image data, when the operation mode of the image forming apparatus is determined to be a printing mode.

11. The method of claim 10, further comprising setting the image data to be downsized or divided, when the obtained image data is not printed in a piece of printing paper,
wherein the performing of the operation comprises printing the image data on a piece of printing paper by downsizing the image data when the image data is set to be downsized; and printing the image data on a plurality pieces of printing papers by dividing the image data when the image data is set to be divided.

12. A method of performing operations in an image forming apparatus, the method comprising:
setting an operation to be performed, when an input button included in the image forming apparatus is selected; and
if it is determined that the input button included in the image forming apparatus is selected, performing an operation according to the setting on image data obtained by capturing from a host device connected to the image forming apparatus.

13. A non-transitory computer-readable recording medium having embodied thereon a program to implement the method of claim 1 which is executed by one or more processors.

14. A non-transitory computer-readable recording medium having embodied thereon a program to implement the method of claim 13 which is executed by one or more processors.

15. An image forming apparatus in which a plurality of operation modes may be set, the image forming apparatus comprising:
a user interface unit including an input button for performing a predetermined operation on image data obtained by capturing from a host device connected to the image forming apparatus;
a control unit to determine whether the input button is selected by a user; and
an operation mode determination unit to determine a current operation mode of the image forming apparatus from among the plurality of operation modes, if it is determined that the input button is selected by the user,
wherein the control unit controls the operation, which was previously set in correspondence to the operation mode to be performed, on the image data according to a result of the determining.

16. The image forming apparatus of claim 15, wherein the previously set operation comprises at least one of a storing operation for storing the image data and a transmitting operation to transmit the image data to an external device.

17. The image forming apparatus of claim 15, further comprising a setting information set-up unit to set at least one selected from the group consisting of an operation to be performed in correspondence to the operation mode, a capture range in the host device, and a format of the obtained image data.

18. The image forming apparatus of claim 17, further comprising a communication interface unit to send/receive data to/from the host device,
wherein the control unit requests the host device for image data according to the setting through the communication interface unit, and controls the operation, which was previously set in correspondence to an operation mode according to a result of the determining, to be performed on the image data received through the communication interface unit.

19. A system for performing an operation comprising an image forming apparatus and a host device connected to the image forming apparatus, the system comprising:
an image forming apparatus to determine whether a user selects an input button for performing a predetermined operation on image data obtained by capturing from a host device connected to the image forming apparatus, to determine, if it is determined that the input button is selected, a current operation mode from among a plurality of operation modes, and to request image data to perform an operation, which was previously set in correspondence to the operation mode, according to a result of the determining; and
a host device to provide image data obtained by capturing according to the request to the image forming apparatus,
wherein the image forming apparatus performs the previously set operation by using the provided image data.

20. The system of claim 19, wherein the previously set operation comprises at least one of a storing operation to store the image data in the image forming apparatus or an external device connected to the image forming apparatus and a transmitting operation to transmit the image data to the external device.
